(19) United States
(12) Patent Application Publication
(10) Pub. No.: US 2006/0159883 A1
(43) Pub. Date: Jul. 20, 2006

(54) Light multilayer sound-absorbing component, in particular for motor vehicles

(76) Inventor: Albert Kallenberg, Hurth (DE)

Correspondence Address: WILLIAM COLLARD;COLLARD & ROE, P.C., 1077 NORTHERN BOULEVARD, ROSLYN, NY, 11576, US

(21) Appl. No.: 10/547,877

(22) PCT Filed: Sep. 23, 2004
(86) PCT No.: PCT/EP04/10662

§ 371 Date: Sep. 2, 2005

(30) Foreign Application Priority Data
Dec. 23, 2003 (DE) 203201027

(51) Int. Cl. B32B 3/02; D04H 11/00; B31B 45/00

(52) U.S. Cl. 428/85; 428/34.1; 442/327

(57) ABSTRACT

The invention relates to a multi-layer, sound-absorbing lightweight component, in particular for motor vehicles. The object of the present invention is to create a sound-absorbing component for motor vehicles which is relatively light and at the same time has a high or even improved acoustic effectiveness compared to conventional components of this type. To achieve this object, a multi-layer component is proposed which has an air-permeable cover layer (17) and at least one air-permeable fleece layer (10″) of thermoplastic fibres, the cover layer (17) being coupled to the fleece layer (10″) in a sound-permissive manner. The component of the present invention is further characterized in that the fleece layer (10″) has a thickness in a range of 2 to 7 mm for a weight per area unit in a range of 500 to 1,500 g/m² and is not connected or is only partially connected to a surface area of less than 20% of its surface facing the cover layer (17).

The invention relates to a multi-layer, sound-absorbing lightweight component, in particular for motor vehicles, having an air-permeable cover layer and at least one air-permeable fleece layer of thermoplastic fibres, the cover layer being coupled to the fleece layer in a sound-transmissive manner.

A plurality of materials and systems for reducing sound emissions from motor vehicles, in particular for reducing the noise level in vehicle passenger compartments, have already been developed.

So-called resonance absorbers are often used for sound insulation in passenger vehicles. These are selective spring-mass systems which are excited to resonance and are optimally effective in the particular resonance range. Elastic fleece materials and/or foam materials coupled to a heavy layer of rubber or an elastomer as the mass are typically used as the spring. Conventional spring-mass systems have only a narrow-band effect. However, it is particularly disadvantageous that they have a relatively high mass per area unit due to the heavy layer mass, which is unfavorable with regard to the total vehicle weight and the permissible maximum load as well as with regard to a lowest possible fuel consumption.

DE 199 60 945 A1 describes a floor covering for motor vehicles which is said to have a particularly low mass per area unit without impairing the acoustic effectiveness. This known floor covering essentially consists of a carpet layer, an underlying sound-insulating element and a soft polyurethane foam layer, the sound-insulating element being formed by a double-layer fleece, namely a polyester fleece and an underlying polypropylene fleece. The double-layer fleece has a mass per area unit of 600 to 1,000 g/m². The carpet layer is a polyamide tufted velour carpet and consists of a polyamide staple fibre layer, a base fleece, and a binding. The double-layer fleece is sintered via a polyethylene sinter layer over the entire surface of the backing of the carpet layer. A polyethylene/polyamide sealing film which seals the double-layer fleece against foam penetration from the polyurethane foam layer formed in the back-foaming process is laminated onto the rear side of the double-layer fleece.

The object of the present invention is to create a component of the type described in the introduction which is relatively light and at the same time has a high or even improved acoustic effectiveness.

According to the present invention, this object is achieved by a component having the features indicated in claim 1.

The sound-absorbing component of the present invention has an air-permeable cover layer and at least one air-permeable fleece layer of thermoplastic fibres, the cover layer being coupled to the fleece layer in sound-transmitting manner. The component is essentially further characterized in that the fleece layer has a thickness in a range of 2 to 7 mm for a weight per area unit in a range of 500 to 1,500 g/m² and is not attached or is only partially attached to the cover layer with a surface area of less than 20% of its surface facing the cover layer.

The component of the present invention is very light compared to conventional sound-insulating coverings which form a spring-mass system having an air-tight heavy layer. According to the present invention, the fleece layer is not attached or is only partially attached to the cover layer. This essentially loose layering results in one or more thin air layers between the layers at least in some areas. Corresponding density differences and accordingly relatively high impedance discontinuities are present at the transitions from the layers to the air layers and provide the lightweight component of the present invention with excellent acoustic qualities. Measurements have shown that despite their low total mass per area unit, components of the present invention have good and in special embodiments even improved sound-insulating properties compared to conventional components having a heavy layer. In particular, measurements have shown that components of the present invention have a relatively high sound-absorbing and sound-insulating effect for medium and high sound frequencies.

The sound-absorbing and sound-insulating fleece layer of the component according to the present invention is preferably formed from polyethylene-terephthalate fibres and/or polypropylene fibres. The air permeability or the flow resistance of the fleece layer is set by compression such that an optimal sound-absorbing and sound-insulating effect is achieved. The thickness of the fleece layer lies preferably in a range of 2 to 5 mm for a weight per area unit in a range of 500 to 1,300 g/m².

An advantageous embodiment of the lightweight component according to the present invention consists in that a further air-permeable fleece layer of thermoplastic fibres is arranged on the side of the fleece layer facing away from the cover layer, both fleece layers having a thickness in a range of 2 to 5 mm and a weight per area unit in a range of 500 to 700 g/m². The two fleece layers may have the same thickness and weight per area unit, e.g., a weight per area unit of 600 g/m² and a thickness of approx. 3 mm. The two fleece layers also preferably lie essentially loosely on or against one another so that their facing layer boundaries define a thin air layer or a density difference and a corresponding impedance discontinuity are present there.

According to a further advantageous embodiment of the present invention, spacers are formed in the at least one fleece layer of thermoplastic fibres. The spacers form thin, air-filled hollow spaces between the fleece layer and the adjacent layer or an adjacent sheet panel. In particular, this embodiment is acoustically particularly effective due to the impedance discontinuity present at the transition between the fleece layer and air layer.

Relatively high sound absorption may be achieved using the lightweight component according to the present invention when an open-cell foam layer is arranged between the cover layer and the fleece layer and has a thickness in a range of 7 to 15 mm and a weight per area unit preferably in a range of only 100 to 200 g/m². In particular, the foam layer may consist of a polyurethane foam or melamine resin foam.

According to an advantageous embodiment, the cover layer of the lightweight component of the present invention may be formed by a polyester fibre fleece having a weight per area unit in a range of 70 to 110 g/m² or a spunbond fabric having a weight per area unit in a range of 60 to 100 g/m². A particularly high sound-absorption coefficient was achieved in an embodiment in which a polyester fibre fleece having a weight per area unit in a range of 70 to 110 g/m² is arranged directly behind the spunbond fabric. In this case the air resistance of the spunbond fabric is preferably greater than that of the polyester fibre fleece.

The lightweight component according to the present invention may be used in a motor vehicle, in particular as an engine-side dashboard covering. Alternatively or additionally, it may also be used to cover the dashboard side facing the passenger compartment, its cover layer then preferably being formed by a carpet layer.

In a particularly preferred embodiment, the carpet layer is made from a tufted carpet having an acoustically open tuft backing and an air-permeable, netted tuft binding.

In this case a further advantageous embodiment consists in that the tuft binding is provided with mineral microbodies and/or hollow mineral microbodies. This renders possible a tufted carpet having a relatively low weight per area unit and simultaneously excellent form stability. The weight per area unit of the carpet layer is in a range of only 200 to 400 g/m², for example.

Further preferred and advantageous embodiments of the lightweight component according to the present invention are described in the dependent claims.

The invention will be explained in the following with reference to a drawing which illustrates several exemplary embodiments. The figures show schematically:

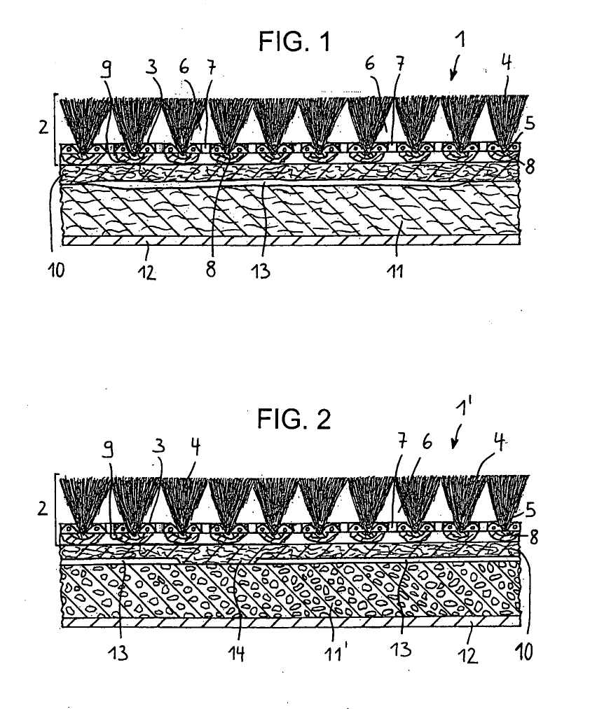

FIG. 1 shows a simplified cross-sectional view of a section of a first lightweight component according to the present invention in the form of motor vehicle floor carpeting;

FIG. 2 shows a simplified cross-sectional view of a section of a second lightweight component according to the present invention in the form of motor vehicle floor carpeting;

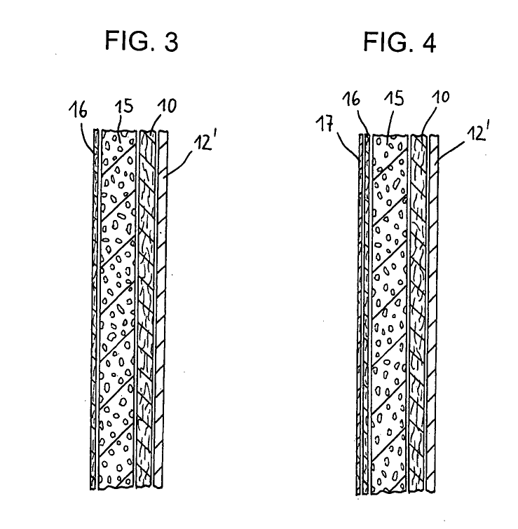

FIG. 3 shows a simplified cross-sectional view of a section of a third lightweight component according to the present invention in the form of an engine-side dashboard covering;

FIG. 4 shows a simplified cross-sectional view of a section of a fourth lightweight component according to the present invention in the form of an engine-side dashboard covering;

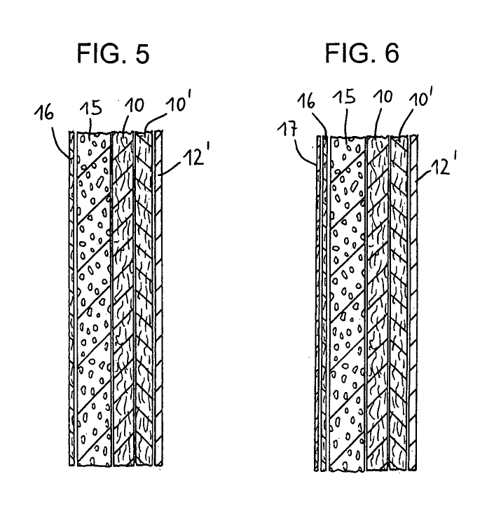

FIG. 5 shows a simplified cross-sectional view of a section of a fifth lightweight component according to the present invention in the form of an engine-side dashboard covering;

FIG. 6 shows a simplified cross-sectional view of a section of a sixth lightweight component according to the present invention in the form of an engine-side dashboard covering;

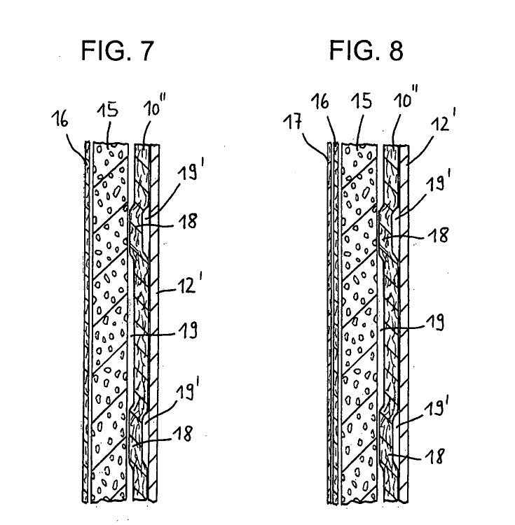

FIG. 7 shows a simplified cross-sectional view of a section of a seventh lightweight component according to the present invention in the form of an engine-side dashboard covering;

FIG. 8 shows a simplified cross-sectional view of a section of an eighth lightweight component according to the present invention in the form of an engine-side dashboard covering;

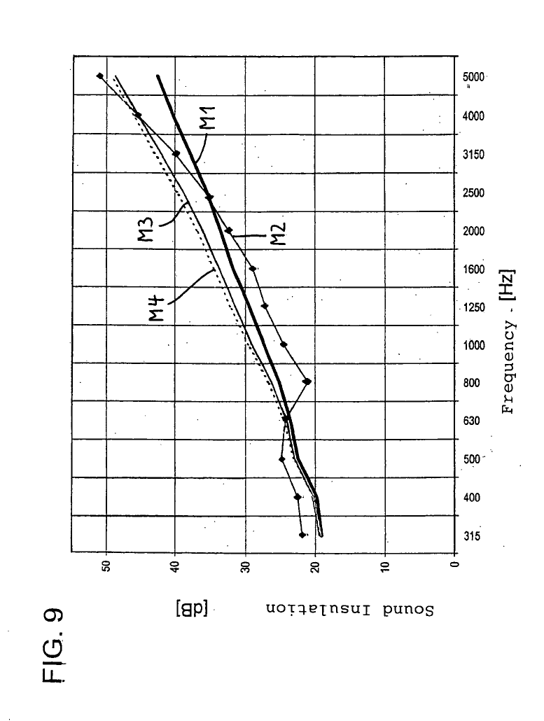

FIG. 9 shows a representation of the sound insulation as a function of the frequency for an air-permeable fleece layer used in a lightweight component according to the present invention without and with an air-permeable spunbond fabric as the cover layer compared to a steel sheet and an air-tight elastomer heavy layer;

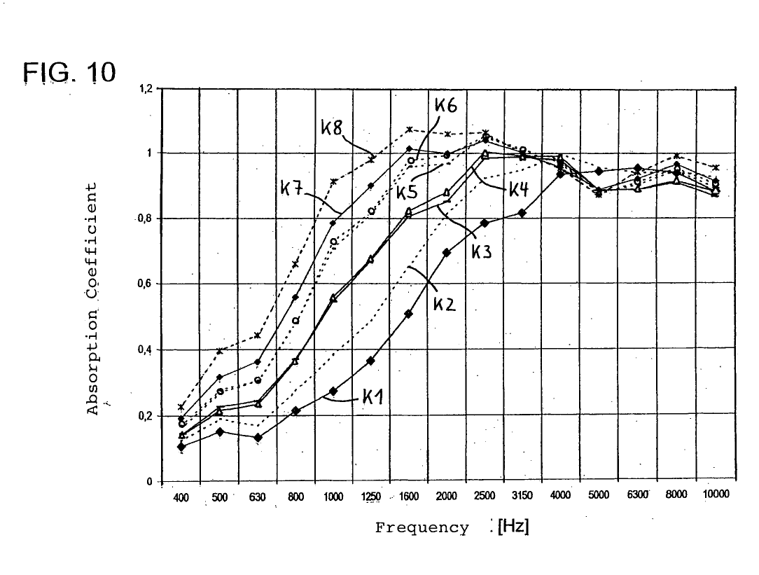

FIG. 10 shows a representation of the sound absorption as a function of the frequency for different lightweight components according to the present invention as engine-side dashboard covering compared to two layer structures suitable as dashboard covering and having an air-tight elastomer heavy layer; and

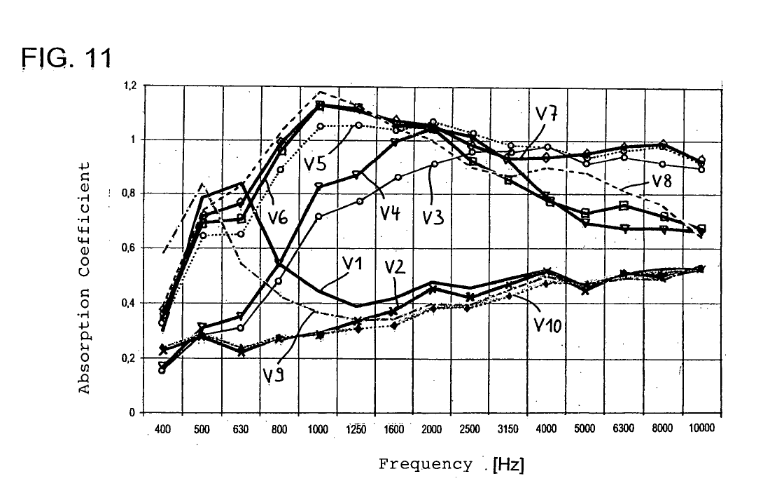

FIG. 11 shows a representation of the sound absorption as a function of the frequency for different lightweight components according to the present invention as passenger compartment-side dashboard or floor coverings having a carpet layer as the cover layer, compared to similar floor carpeting structures, but including an air-tight carpet backing.

FIG. 1 shows a section of a floor carpeting structure 1 for a motor vehicle representing a lightweight component in comparison with conventional vehicle floor carpeting structures having a heavy layer as the sound-insulating mass in the manner of a spring-mass system. Floor carpeting structure 1 according to the present invention is formed from a tufted velour carpet layer. Reference numeral 3 denotes a tuft backing into which pile threads 4 or pile loops 5 are inserted. Tuft backing 3 consists of a fleece, e.g. a polyester spunbond fabric. It can be seen that the tuft backing 3 has a plurality of perforations 7 defining pile gaps 6 created by pile-threadless tufting needles. The pile gaps 6 increase the acoustically effective air volume in the velour carpet layer 2. The velour carpet layer 2 has a largely homogenous pile density over its entire surface.

To bind the pile loops 5 inserted into the tuft backing 3, a first adhesive 8 is first applied to the underside, which adhesive essentially accumulates only at pile bindings 5 when applied leaving perforations 7 created by the pile-threadless tufting needles essentially free. A further powder adhesive 9 is sintered onto this tuft binding. The first adhesive 8 and/or the sintered powder adhesive 9 preferably contain(s) mineral microbodies and/or hollow mineral microbodies (not shown). The carpet layer 2 has a weight per area unit in a range of 200 to 400 g/m², e.g. 350 g/m².

An air-permeable fleece layer 10 of thermoplastic fibres is arranged next to the carpet layer 2. The air resistance of the fleece layer preferably formed from PET fibres and/or PP fibres is set or optimized via compression. Given a weight per area unit in a range of 500 to 1,300 g/m², the thickness of fleece layer 10 is in a range of 2 to 7 mm, in particular between 2 and 5 mm for a weight per area unit in a range of approx. 600 to approx. 1,000 g/m².

The fleece layer 10 is not attached or is only partially attached to the carpet layer 2. The partial attachment is achieved via heat-sealing and is limited to an edge region and, in some instances, the edge region of one of more openings for cables, hoses, and/or mechanical control elements. The surface area of fleece layer 10 connected in a substance-to-substance bond to carpet layer 2 is max. 20%, but preferably significantly less than 20%, of it surface facing carpet layer 2.

A layer 11 formed from a cotton fibre fleece and resting on floor panel 12 of the vehicle is arranged underneath fleece layer 10. The cotton fibre fleece 11 has a weight per area unit in a range of approx. 600 to 1,100 g/m², in particular in a range of approx. 700 to 1,000 g/m². Given a weight per area unit in a range of approx. 600 to 700 g/m², the thickness is approx. 6 mm. Given a weight per area unit in a range of 1,000 to 1,100 g/m², the cotton fibre fleece has a thickness of approx. 15 to 20 mm.

It can be seen that the fleece layer 10 rests on cotton fibre fleece 11 in an essentially loose manner so that thin air layers or air chambers 13 are present between layers 10, 11. The two layers 10, 11 are not connected or are only partially connected to one another, the connection being arranged in the edge region of the lightweight component formed by layers 2, 10, and 11 and/or in the edge region of openings formed therein (not shown).

In FIG. 2 a further motor vehicle floor carpeting structure 1′ according to the present invention is shown, which structure corresponds largely to the floor carpeting structure according to FIG. 1. It differs from the floor carpeting structure according to FIG. 1 essentially in that a foam layer 11′ instead of a cotton fibre fleece is arranged underneath fleece layer 10. Layers 2, 10, and 11′ also lie on one another in an essentially loose manner in this floor carpeting structure. Recesses or elevations 14 for forming thin air chambers 13 may also be formed in fleece layer 10. Foam layer 11′ preferably consists of an open-cell soft polyurethane foam, in particular cold foam. Foam layer 11′ has a thickness in a range of approx. 15 to 22 mm for a weight per area unit in a range of approx. 900 to 1,300 g/m².

FIGS. 3 through 8 show sections of engine-side dashboard coverings also designed as lightweight components. Reference numeral 12′ denotes a dashboard sheet panel. The inner side of dashboard sheet panel 12′ is at least regionally covered by a floor carpeting structure 1 or 1′ according to FIG. 1 and FIG. 2, respectively (not shown in FIGS. 3 through 8).

The dashboard coverings shown in FIGS. 3 and 4 have an air-permeable fleece layer 10 which rests on dashboard 12′ in an essentially loose manner and is formed from thermoplastic fibres, preferably PET fibres and/or polypropylene fibres. The air resistance of fleece layer 10 is again set by the degree of compression of the fibre fleece. Fleece layer 10 has a thickness in a range of approx. 2 to 5 mm, e.g. approx. 3 mm, for a weight per area unit in a range of approx. 500 to 1,100 g/m². Fleece layer 10 is covered by an open-cell foam layer 15. The foam is polyurethane foam or melamine resin foam, for example. Foam layer 15 has a weight per area unit in a range of approx. 100 to 200 g/m² and a thickness in a range of approx. 7 to 15 mm, e.g. approx. 9 mm.

In the direction of the engine compartment, the dashboard covering has a relatively thin, air-permeable fleece layer 16 as a cover layer. In the exemplary embodiment according to FIG. 3, the cover layer consists of a polyester fibre fleece 16 having a weight per area unit in a range of approx. 70 to 110 g/m². The thickness of polyester fibre fleece 16 is less than 1 mm, preferably less than 0.8 mm.

In the exemplary embodiment according to FIG. 4, the cover layer consists of a thin spunbond fabric 17, a polyester fibre fleece 16 according to FIG. 3 being arranged directly behind spunbond fabric 17. Spunbond fabric 17 has a weight per area unit in a range of 60 to. 100 g/m², e.g. approx. 80 g/m², and a higher air resistance than polyester fibre fleece 16.

The sections of the dashboard coverings according to the present invention shown in FIGS. 5 and 6 differ from the exemplary embodiments shown in FIGS. 3 and 4 in that a further air-permeable fleece layer 10′ of thermoplastic fibres is arranged on the side of fleece layer 10 facing away from the cover layer. Both fleece layers 10, 10′ have a thickness in a range of 2 to 5 mm and a weight per area unit in a range of 500 to 700 g/m².

As shown in FIGS. 7 and 8, spacers 18 may advantageously also be formed, in particular stamped, in fleece layer 10″ to create defined thin air chambers 19, 19′ between layers 10″, 15 and between fleece layer 10″ and dashboard sheet panel 12′, respectively.

Layers 10, 10′, 10″, 15, 16 and in some instances 17 of the dashboard covering according to FIGS. 3 through 8 lie on one another in a loose manner so that thin air layers are formed between the layers. Layers 10, 10′, 10″, 15, 16, 17 are only attached to dashboard sheet panel 12′ at certain points or locations openings (not shown) present in dash board sheet panel 12′, e.g. for a heating and air conditioning system, electrical cables, Bowden cables, linkage systems, levers, or the steering shaft, are acoustically sealed by flexible, adaptable layers 10, 10′, 10″, 15, 16, 17 of the lightweight component of the present invention.

FIG. 9 shows comparative measurements of the sound insulation as a function of the frequency for an air-permeable fleece layer used in a lightweight component according to the present invention without and with an air-permeable spunbond fabric as the cover layer in relation to a 0.8 mm thick steel sheet and a heavy layer having a weight per area unit of approx. 3.25 kg/m². Measured curve M1 shows the sound insulation resulting for the steel sheet. It can be seen that the sound insulation is generally greater for higher sound frequencies. Measured curve M2 shows the measured values for the heavy layer. Due to resonance influences, the sound insulation of the heavy layer was in a frequency range of approx. 700 to 2,500 Hz less than the sound insulation effect of the bare steel sheet. Measured curve M3 shows the measured values for a fleece layer compressed to a thickness of approx. 3 mm and having a weight per area unit of approx. 600 g/m². It is surprising that the sound insulation achieved using this air-permeable fleece layer is relatively high compared to the heavy layer. Dashed measured curve M4 shows the measured values for a corresponding fleece layer additionally covered in the direction of the sound side with a spunbond fabric having a weight per area unit of approx. 80 g/m².

FIG. 10 shows the sound absorption as a function of the frequency for different lightweight components according to the present invention as dashboard coverings compared to two layer structures suitable as dashboard coverings and including a heavy layer having a weight per area unit of approx. 3.2 kg/m².

Curve K1 shows the measured values for a layer structure made up of 3.2 kg/m² of an air-tight heavy layer, an open-cell PUR foam layer having a thickness of approx. 9 mm, and an air-permeable PES fleece. Dashed curve K2 relates to a corresponding layer structure additionally having a spunbond fabric having a weight per area unit of approx. 80 g/m² as the cover layer on the PES fleece.

Curve K3 corresponds to the absorption measurement for a layer structure according to the present invention in which a compressed, air-permeable fleece layer having a thickness of approx. 3 mm and a weight per area unit of only approx. 600 g/m² is used instead of the mentioned heavy layer. Curve K4 which is characterized by triangles relates to a similar layer structure in which the weight per area unit of the compressed, air-permeable fleece layer is approx. 1,000 g/m².

Curves K5 and K6 relate to layer structures according to the present invention having a compressed, air-permeable fleece layer, an open-cell PUR foam layer having a thickness of approx. 9 mm, and a relatively thin, air-permeable PES fleece layer. The layer structure belonging to curve K5 also includes a thin spunbond fabric having a weight per area unit of approx. 80 g/m² as the cover layer, the compressed, air-permeable fleece layer having a thickness of approx. 3 mm and a weight per area unit of approx. 600 g/m². Curve K6 belongs to a corresponding layer structure also having a thin spunbond fabric having a weight per area unit of approx. 80 g/m² as the cover layer, but the weight per area unit of the approx. 3 mm thick, compressed, air-permeable fleece layer being approx. 1,000 g/m² for this layer structure.

Curves K7 and K8 relate to layer structures differing from the layer structures of curves K3 and K5 in that a further corresponding fleece layer is arranged on the side of the compressed, air-permeable fleece layer facing away from the cover layer, i.e., both fleece layers lying loosely on one another have a thickness of approx. 3 mm and a weight per area unit of approx. 600 g/m². Curve K8 belongs to the layer structure having a thin spunbond fabric having a weight per area unit of approx. 80 g/m² as the cover layer.

As curves K3, K5, K7, K8 show, the thin, very light spunbond fabric and the use of the two air-permeable fleece layers lying loosely on one another result in a significant improvement of the sound absorption.

Finally, FIG. 11 shows the sound absorption as a function of the frequency for different dashboard or floor coverings according to the present invention having a carpet layer as the cover layer and an air-permeable base, compared to floor carpeting structures equipped with an air-tight carpet backing.

Curve V10 belongs to a floor carpeting structure formed from a carpet upper fabric having a heavy layer backing and a cold foam layer positioned underneath it, the cold foam layer having a weight per area unit of approx. 1,200 g/m². Measurement curve V9 is based on a floor carpeting structure including a corresponding cold foam layer but also having another carpet upper fabric with a foil backing.

Curve V1 shows the measurement results for a floor carpeting structure formed from a carpet upper fabric having a heavy layer backing, a fleece layer following thereon and having a weight per area unit of 1,000 g/m², and a cotton fibre fleece following thereon and having a weight per area unit of 700 g/m². Curve V2 shows the measurement results for a floor carpeting structure also having a fleece layer having a weight per area unit of 1,000 g/m² and a cotton fibre fleece having a weight per area unit of 700 g/m² as a sub-layer, but having the other carpet upper fabric having the film backing.

Curves V3 and V8 relate to floor carpeting structures having an acoustically open velour carpet layer as the upper fabric according to FIGS. 1 and 2 having a weight per area unit of approx. 350 g/m² and an air-permeable, approx. 3 mm thick, compressed fleece layer having a weight per area unit of approx. 1,000 g/m². The floor carpeting structures belonging to curves V3 and V4 also include a cotton fibre fleece having a weight per area unit of approx. 700 g/m² as the bottom layer. However, in the case of the floor carpeting structures on which curves V5 and V6 are based, a cotton fibre fleece having a weight per area unit of approx. 1,000 g/m² is used as the bottom layer, and in the case of the floor carpeting structures on which curves V7 and V8 are based, a cold foam having a weight per area unit of approx. 1,200 g/m² is used as the bottom layer. Finally, the measured floor carpeting structures differ in that in the case of the floor carpeting structures on which curves V4, V6, V8 are based, an approx. 40 μm thick plastic film is arranged between the carpet upper fabric and the approx. 3 mm thick, air-permeable fleece layer. The comparison of curves V4, V6, and V8 with curves V3, V5, and V7 shows that the floor carpeting structures equipped with the plastic film have significantly lower sound absorption coefficients at higher frequencies than the floor carpeting structures of the present invention without a plastic film.

1. A multi-layer, sound-absorbing component, in particular for motor vehicles, having an air-permeable cover layer (2, 16, 17) and at least one air-permeable fleece layer (10, 10′, 10″) of thermoplastic fibres, the cover layer (2, 16, 17) being coupled to the fleece layer (10, 10′, 10″) in a sound-transmissive manner, that wherein the fleece layer (10, 10′, 10″) has a thickness in a range of 2 to 7 mm for a weight per area unit in a range of 500 to 1,500 g/m² and is not connected or only partially connected to the cover layer (2, 16, 17) with a surface area of less than 20% of its surface facing the cover layer (2, 16, 17).

2. The component according to claim 1, wherein the fleece layer (10, 10′, 10″) has a thickness in a range of 2 to 5 mm for a weight per area unit in a range of 500 to 1,300 g/m².

3. The component according to claim 1, wherein the fleece layer (10, 10′ 10″) is formed from polyethylene-terephthalate fibres and/or polypropylene fibres.

4. The component according to claim 1, that wherein the cover layer (2, 16, 17) and the fleece layer (10, 10′, 10″) are only connected with one another in an edge region of the fleece layer and/or in an edge region of an opening formed in the cover layer (2, 16, 17) as well as the fleece layer (10, 10′, 10″).

5. The component according to claim 1, wherein a further air-permeable fleece layer (10′) of thermoplastic fibres is arranged on the side of the fleece layer (10) facing away from the cover layer (2, 16, 17), each fleece layer (10, 10′) having a thickness in a range of 2 to 5 mm and a weight per area unit in a range of 500 to 700 g/m².

6. The component according to claim 1, wherein an open-cell foam layer (15) is arranged between the cover layer (16, 17) and the fleece layer (10, 10″) of thermoplastic fibres.

7. The component according to claim 6, wherein the foam layer (15) has a thickness in a range of 7 to 15 mm for a weight per area unit in a range of 100 to 200 g/m².

8. The component according to claim 6, wherein the foam layer (15) is made of polyurethane foam or melamine resin foam.

9. The component according to claim 1, wherein the cover layer is formed by a polyester fibre fleece (16) having a weight per area unit in a range of 70 to 110 g/m² or a spunbond fabric (17) having a weight per area unit in a range of 60 to 100 g/m².

10. The component according to claim 9, wherein a polyester fibre fleece (16) having a weight per area unit in a range of 70 to 110 g/m² is arranged directly behind the spunbond fabric (17).

11. The component according to claim 1, wherein the cover layer is formed by a carpet layer (2).

12. The component according to claim 11, wherein the carpet layer (2) is formed by a tufted carpet having an acoustically open tuft backing (3) and an air-permeable, netted tuft binding.

13. The component according to claim 12, wherein the tuft binding is provided with mineral microbodies and/or hollow mineral microbodies.

14. The component according to claim 11, wherein the carpet layer (2) has a weight per area unit in a range of 200 to 400 g/m².

15. The component according to claims 1, wherein an open-cell foam layer (11′) or a layer (11) formed from a cotton fibre fleece is arranged on the side of the fleece layer (10) facing away from the cover layer (2).

16. The component according to claim 15, wherein the cotton fibre layer (11) has a thickness in a range of 5 to 20 mm for a weight per area unit in a range of 600 to 1,100 g/m².

17. The component according to claim 15, wherein the foam layer (11′) has a thickness in a range of 15 to 22 mm for a weight per area unit in a range of 900 to 1,300 g/m².

18. The component according to claims 1, wherein elevations (14) or spacers (18) are formed in the fleece layer (10, 10″) of thermoplastic fibres.
